(19) United States
(12) Patent Application Publication
(10) Pub. No.: US 2009/0286113 A1
(43) Pub. Date: Nov. 19, 2009

(54) Fuel Cell, Supply And Disposal Unit For Fuel Cells, And Method For Removing Reaction Products From Fuel Cells

(76) Inventors: Christian Wachtel, Freiburg (DE); Matthias Krieg, Freiburg (DE); Thomas Jungmann, Freiburg (DE); Michael Oszcipok, Weilheim (DE)

Correspondence Address: HENRICKS SLAVIN AND HOLMES LLP;SUITE 200, 840 APOLLO STREET, EL SEGUNDO, CA, 90245, US

(21) Appl. No.: 12/468,037

(22) Filed: May 18, 2009

(30) Foreign Application Priority Data
May 19, 2008 (DE) 102008024190.3

(51) Int. Cl. H01M 8/04; H01M 2/02

(52) U.S. Cl. 429/13; 429/34; 429/26

(57) ABSTRACT

The inventions relate to a fuel cell in which the disposal of reaction products is possible in a particularly advantageous manner and also to a supply and disposal unit which can be part of such a fuel cell or can be connected to such a fuel cell. The inventions relate in addition to a method for the disposal of reaction products from fuel cells.

### BACKGROUND

The inventions relate to a fuel cell in which the disposal of reaction products is possible in a particularly advantageous manner and also to a supply and disposal unit which can be part of such a fuel cell or can be connected to such a fuel cell. The inventions relate in addition to a method for the disposal of reaction products from fuel cells.

Fuel cells convert reactants while generating electrical energy into reaction products. For this purpose, the reactants of the fuel cell must be supplied from a tank and the reaction products must be discharged or removed. Both reactants and reaction products can be liquid or gaseous. Possible reactants are for example water, alcohol, hydrogen and oxygen. Reaction products can be for example water, CO₂ and others.

In particular, transporting away or removing the reactions products is problematic. Above all in the case of gaseous products, resulting gas bubbles in gas distributor structures of the fuel cell (flow field) which distribute the reactants can impede the transporting to and away of fuel and consequently impair the operating behaviour of the fuel cell. The problem of transporting the product away is further increased in that, in many types of fuel cells, the reaction chamber of the fuel cell (e.g. a small space between the reactant tank and the anode) and/or the anode chamber of the fuel cell (which is also a “reaction chamber”) must be sealed in order that in particular gaseous reactants and/or products do not pass into the environment without being impeded.

The mentioned problems occur in particular also with direct alcohol fuel cells in which alcohol and oxygen is converted into water and carbon dioxide. In the case of liquid-operated direct alcohol fuel cells, a two-phase mixture with CO₂ and water is produced here. If the carbon dioxide gas bubbles are not removed from the fuel cell, they impede the fuel transport as described above. In addition, the pressure in the system is increased by the resulting CO₂, as a result of which the operating behaviour is likewise impaired. Furthermore, the carbon dioxide also blocks the catalyst places with the effect that the fuel cannot react catalytically without hindrance.

In the state of the art, the resulting CO₂ is conducted out of the reaction chamber via the fuel in the case of direct methanol fuel cells (DMFCs). Subsequently, the CO₂ could be discharged to the environment from the system via a phase separation membrane (CO₂ membrane). In the case of vapour- or gas-operated, passive direct methanol fuel cells in which no fuel circulates and in which a methanol CO₂ mixture is produced in the reaction chamber, it was proposed that CO₂ be discharged via an outlet opening in which a CO₂ membrane, i.e. a semi-permeable gas separation membrane, is disposed. In the solutions according to the state of the art it is problematic that it cannot be ensured, as a result of the low selectivity of the membranes, that no methanol escapes.

### SUMMARY

It is the object of the present inventions to provide a fuel cell, a supply and disposal unit for fuel cells and also a method for removing reaction products from fuel cells, which make it possible to remove reaction products from the fuel cell simply and reliably without further substances escaping. The fuel cells according to the inventions, the supply and disposal units and also the methods should be able to be produced or operated and implemented in as simple and economical a manner as possible.

These objects are achieved by the present fuel cells, supply and disposal units and methods for removing reaction products from fuel cells.

According to at least one of the inventions, at least one reaction product produced in a fuel cell is absorbed by at least one chemical adsorber. The reaction product can, for example, be CO₂.

The at least one chemical absorber may be disposed in a container, subsequently termed “absorber container,” which is connected to a reaction chamber of the fuel cell and/or to an anode chamber and/or a cathode chamber of the fuel cell via at least one line which is permeable for the reaction product. The line can be in general gas- and/or liquid-permeable, however it is also possible that filters and/or membranes, in particular semi-permeable membranes, are disposed in the line, which are permeable only for the reaction product or products.

The absorber container can be disposed also directly at the reaction chamber and/or at the anode chamber and/or cathode chamber of the fuel cell such that the reaction product can pass from the corresponding chamber into the absorber container. It is also possible in particular that the absorber is disposed in the corresponding chamber itself.

The absorber may be connected to the reaction chamber and/or from the anode chamber and/or the cathode chamber via at least one membrane, such as a phase separation membrane.

The absorber can be disposed and/or configured such that it can be connected, removed and/or exchanged together with a tank of the fuel cell. This has the advantage that the fuel cell can be maintained in only one step in which new fuel is made available in the tank, on the one hand, and, on the other hand, consumed absorber is exchanged and/or regenerated.

Such an embodiment can be achieved particularly advantageously if the tank and the absorber container are configured as one integral unit such as, for example, a cartridge that includes the tank and absorber container. The tank and absorber container are then therefore preferably two containers and/or chambers, between which preferably no direct gas- or liquid exchange can take place but which are in communication, connected to each other, disposed adjacently and/or configured abutting against each other. Thus, the tank or tanks and also the absorber container or containers can be configured as hollow bodies, if necessary filled with absorber material, which can be assemblable, glued together, welded together or which can exist in one total volume which is subdivided by one or more separating walls into tank and absorber container. For example, the tank and absorber container can form a common cuboid volume, extending in a plane for example, the absorber container being a volume surrounding the tank or the tank being a volume surrounding the absorber container. Tank and absorber can hereby completely fill respectively an extension of the total volume, such as for example the depth, and surround each other in the described manner in both other dimensions. The reaction chamber and/or the anode chamber and/or the cathode chamber of the fuel cell may be disposed in this case such that a connection to the tank and to the absorber exists or can be produced. If the above-described common volume of tank and absorber container is a cuboid extended in a plane, then for example the reaction chamber and/or the anode chamber and/or the cathode chamber of the fuel cell can likewise be extended in a plane and abut with one of its two large surfaces against one of the large surfaces of the common volume comprising tank and absorber or in part against tank and in part against absorber or only against the tank. However, at least one shutter (e.g. a device with a plurality of fins which allow gas to flow when in an open position and prevent gas flow when in a closed position) may be disposed between the corresponding chamber of the fuel cell and the corresponding container or tank, with which shutter the transport of reactants and products into the fuel cell or out of the fuel cell can be controlled and/or regulated.

One embodiment of absorber containers and tanks which can be connected together to a fuel cell is particularly advantageous. The lines which lead from the tank to the fuel cell and which lead from the absorber container to the fuel cell can hereby configured as plug-in connections which can be inserted into corresponding bushes (or “connections”) in the fuel cell. However, an arrangement in which the mentioned connections of tank and absorber are configured as separate channels in a single plug-in connection may also be employed. In this case, e.g. a channel which extends in the plug-in connection can be subdivided into two independent channels by an intermediate face.

In some embodiments where the fuel cell and/or the absorber container and/or the tank together form a closed system, i.e. that, in the connected state, the system may be configured such that no materials from the common system can escape in an undesired manner. The closed system may, however, be configured such that the fuel cell, the absorber chambers and/or the tanks can be connected and/or separated as described above. It is also possible to dispose closable openings on one or more of the mentioned units which enable direct filling or direct emptying of the corresponding element with products and/or reactants.

Advantageously, the absorber container can be disposed and/or configured such that reaction heat and/or reaction water which is released during absorption of the product or products by the absorber can be used for the reaction of the fuel cell.

For this purpose, the reaction heat from the absorption can be transferred via the absorber container to the tank in the case of vapour-operated direct alcohol fuel cells. For this purpose, the absorber container can be disposed around the tank. In some implementations, the absorber container or the wall thereof has or comprises a good thermally-conductive material such as, for example, metal.

The heat transferred to the tank then increases the evaporation and/or vaporisation rate of the alcohol, as a result of which more alcohol can pass into the reaction chamber, as a result of which the operating behaviour would be increased or improved. In general, the reaction heat of the absorption can advantageously be conducted via heat exchangers for example to the tank and/or to the reaction chamber of the fuel cell and hence have respectively a positive effect there on the operating behaviour of the fuel cell. Furthermore, the reaction heat and the reaction water of the absorption can be transported via forced flows to the reaction chamber. A forced flow can be achieved for example, as described above, by pressure differences. As a further possibility for transporting reaction water out of the absorption container, an inclination for discharging or an outlet or a collection tank with a hose connection to the reaction chamber can also be produced with suitable arrangements of the fuel cell system.

The absorber may be, among other things, one or more chemical absorbers, such as carbon dioxide absorbent lime, Ca (OH)₂ and others.

The present fuel cells may, for example, be direct alcohol fuel cells and/or direct methanol fuel cells. These fuel cells can be liquid-operated fuel cells, gas-operated fuel cells or vapour-operated fuel cells.

The absorber container may be structured in its interior such that the reaction product or products to be absorbed in the absorber container can be distributed so that the products pass as quickly as possible to the absorber and/or are distributed as uniformly as possible over or in the absorber and/or reach as large a surface as possible of the absorber. For this purpose, there can be disposed in the absorber container flow channels, tapered sections, widened sections and/or baffle plates.

The absorber and/or the absorber container may be configured such that, as a result of partial pressure differences and/or partial pressure changes which are produced by absorption of reaction products in the absorber, the flow of the reaction product in and/or through the absorber can be actuated or accelerated. For this purpose, for example the absorber container can be connected in a pressure-tight manner to the reaction chamber and/or to the anode chamber so that reaction products from the fuel cell are suctioned into the absorber container by a low pressure in the absorber container.

### BRIEF DESCRIPTION OF THE DRAWINGS

Detailed descriptions of exemplary embodiments will be made with reference to the accompanying drawings. The features shown in the drawings can also be produced individually and can be combined with each other from various examples.

FIG. 1 is a diagrammatic view of a fuel cell according to at least one embodiment of a present invention,

FIG. 2A is a side view of a fuel cell according to at least one embodiment of a present invention, and

FIG. 2B is a plan view of the fuel cell illustrated in FIG. 2A.

### DETAILED DESCRIPTION

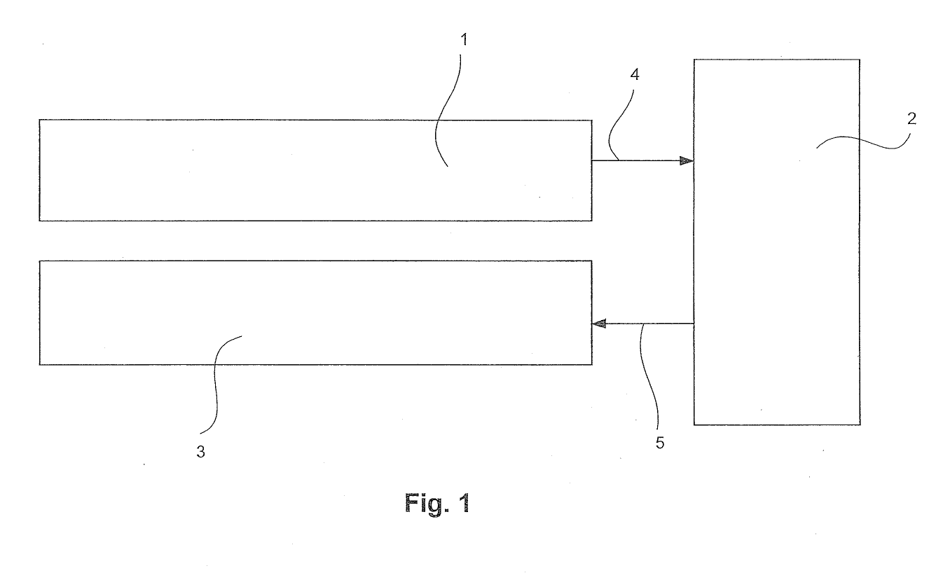

FIG. 1 shows by way of example a first possible embodiment of the fuel cell according to at least one of the inventions. The illustrated fuel cell is a direct alcohol fuel cell. It has a tank 1 in which alcohol can be stored. The tank 1 is connected to a reaction chamber 2 of a direct alcohol fuel cell via a line 4 which is permeable for alcohol. Via the line 4, the reactant alcohol can therefore be conducted from the tank 1 into the reaction chamber 2 of the fuel cell.

The illustrated fuel cell has in addition an absorber container 3 which is connected to the reaction chamber 2 via a line 5 which is permeable for the reaction product, here carbon dioxide. Via the line 5, carbon dioxide can therefore be conducted from the reaction chamber into the absorber container 3 in the illustrated example. At least one chemical absorber is accommodated in the absorber container 3.

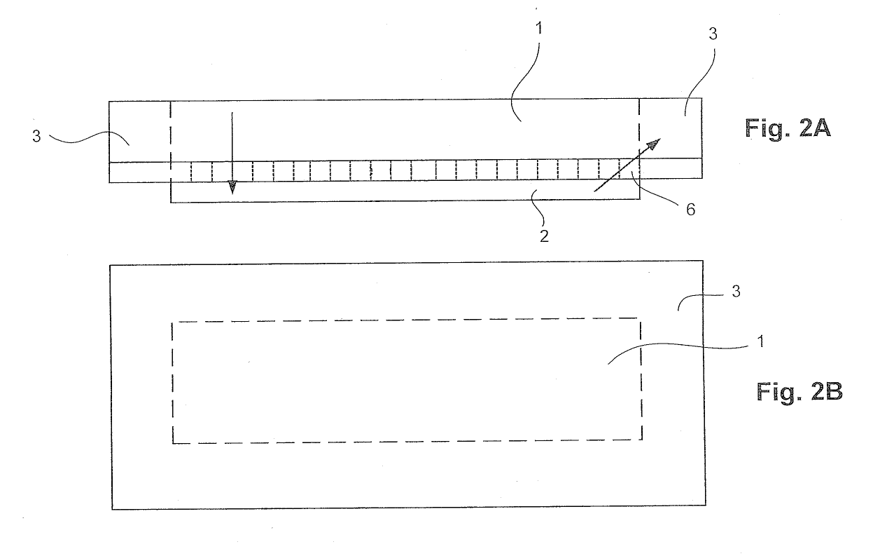

FIG. 2A shows by way of example a second possible embodiment of a fuel cell according to at least one of the inventions. A tank 1 and an absorber chamber 3 hereby form a mainly two-dimensionally extended common cuboid volume. In some instances, the volume may be embodied in a cartridge. In the absorber chamber 3, again at least one chemical absorber is disposed and at least own fuel, such as for example alcohol, can be filled in the tank 1. The tank 1 is connected via a shutter 6 to a reaction chamber 2 of a fuel cell. Via the shutter 6, fuel from the tank 1 can therefore flow into the reaction chamber 2. Furthermore, at least one reaction product can flow from the reaction chamber 2 into the absorber container 3 via the shutter. The illustrated arrangement is advantageous above all when a compact arrangement is desired.

FIG. 2B shows the fuel cell shown in FIG. 2A in plan view. It can be detected that the tank 1 and the absorber chamber 3 form a common large rectangular surface. In this large surface of the common two-dimensional volume, the absorber container 3 surrounds the tank 1, the tank 1 and the absorber container 3, as can be detected in FIG. 2A, having the same height perpendicular to this large surface.

1. A fuel cell, comprising:
a chamber; and
at least one chemical absorber, associated with the chamber, with which at least one reaction product produced in the fuel can be absorbed.

2. A fuel cell as claimed in claim 1, wherein the at least one reaction product contains or is CO₂.

3. A fuel cell as claimed in claim 1, wherein the chamber comprises a reaction chamber and/or an anode chamber and the absorber is disposed in an absorber container which is connected to the reaction chamber and/or to the anode chamber of the fuel cell via a line which is permeable for the reaction product.

4. A fuel cell as claimed in claim 3, wherein the reaction chamber and/or the anode chamber is connected to the absorber container via at least one phase separation membrane.

5. A fuel cell as claimed in claim 4, wherein the absorber container is configured with a tank of the fuel cell as an integral unit.

6. A fuel cell as claimed in claim 5, wherein the absorber container is configured with the tank as a common cartridge which can be connected to the fuel cell such that a connection which is permeable for a fuel is produced between the tank and the reaction chamber and/or anode chamber and a connection which is permeable for the reaction product is produced between the absorber container and the reaction chamber or anode chamber, the tank and the absorber container preferably being connectable together to the reaction chamber.

7. A fuel cell as claimed in claim 1, wherein the absorber comprises or consists of carbon dioxide absorbent lime and/or Ca (OH)₂.

8. A fuel cell as claimed in claim 5, wherein the fuel cell and/or the absorber container and/or the tank together form a closed system.

9. A fuel cell as claimed in claim 5, wherein the absorber container is disposed and/or configured such that, during absorption of the reaction product by the absorber, released reaction heat and/or released reaction water can be used for the fuel cell reaction, that the absorber container is disposed surrounding the tank with the tank in a thermally conducting connection and/or that the absorber container comprises or consists of a heat-conductive material and/or in that at least one heat exchanger is disposed between the absorber container and the tank and/or between the absorber container and the reaction chamber and/or the anode chamber.

10. A fuel cell as claimed in claim 1, wherein the fuel cell is a direct alcohol fuel cell and/or a direct methanol fuel cell.

11. A fuel cell as claimed in claim 1, wherein the fuel cell is a liquid-operated fuel cell or a gas-operated fuel cell.

12. A fuel cell as claimed in claim 3, wherein the absorber container has at least one flow channel and/or at least one tapered section and/or at least one baffle plate with which the reaction product can be conducted through the absorber container.

13. A fuel cell as claimed in claim 3, wherein the absorber container is configured such that, as a result of pressure and/or partial pressure differences and/or changes which are produced by the absorption of the reaction product in the absorber, the flow of the reaction product into and/or through the absorber is actuated.

14. A supply and disposal system for a fuel cell, comprising:
at least one tank for at least one fuel, and at least one absorber container in which at least one absorber is disposed,
the supply and disposal system being able to be connected to a fuel cell such that the at least one fuel can flow or stream from the tank into a reaction chamber of the fuel cell and in that at least one reaction product can flow or stream from the reaction chamber and/or anode chamber of the fuel cell into the absorber container.

15. (canceled)

16. A method, comprising the step of:
removing reaction products from a fuel cell with an absorber.

17. (canceled)

18. A supply and disposal system as claimed in claim 14, wherein the supply and disposal system is configured to be connected to, or is a part of, a fuel cell including a chamber and at least one chemical absorber, associated with the chamber, with which at least one reaction product produced in the fuel can be absorbed.

19. A supply and disposal system as claimed in claim 18, wherein the at least one reaction product contains or is CO₂.

20. A supply and disposal system as claimed in claim 18, wherein the chamber comprises a reaction chamber and/or an anode chamber and the absorber is disposed in an absorber container which is connected to the reaction chamber and/or to the anode chamber of the fuel cell via a line which is permeable for the reaction product.

21. A supply and disposal system as claimed in claim 20, wherein the reaction chamber and/or the anode chamber is connected to the absorber container via at least one phase separation membrane.

22. A supply and disposal system as claimed in claim 21, wherein the absorber container is configured with a tank of the fuel cell as an integral unit.

23. A supply and disposal system as claimed in claim 22, wherein the absorber container is configured with the tank as a common cartridge which can be connected to the fuel cell such that a connection which is permeable for a fuel is produced between the tank and the reaction chamber and/or anode chamber and a connection which is permeable for the reaction product is produced between the absorber container and the reaction chamber or anode chamber, the tank and the absorber container preferably being connectable together to the reaction chamber.

24. A supply and disposal system as claimed in claim 18, wherein the absorber comprises or consists of carbon dioxide absorbent lime and/or Ca (OH)₂.

25. A supply and disposal system as claimed in claim 22, wherein the fuel cell and/or the absorber container and/or the tank together form a closed system.

26. A supply and disposal system as claimed in claim 22, wherein the absorber container is disposed and/or configured such that, during absorption of the reaction product by the absorber, released reaction heat and/or released reaction water can be used for the fuel cell reaction, that the absorber container is disposed surrounding the tank with the tank in a thermally conducting connection and/or that the absorber container comprises or consists of a heat-conductive material and/or in that at least one heat exchanger is disposed between the absorber container and the tank and/or between the absorber container and the reaction chamber and/or the anode chamber.

27. A supply and disposal system as claimed in claim 18, wherein the fuel cell is a direct alcohol fuel cell and/or a direct methanol fuel cell.

28. A supply and disposal system as claimed in claim 18, wherein the fuel cell is a liquid-operated fuel cell or a gas-operated fuel cell.

29. A supply and disposal system as claimed in claim 20, wherein the absorber container has at least one flow channel and/or at least one tapered section and/or at least one baffle plate with which the reaction product can be conducted through the absorber container.

30. A supply and disposal system as claimed in claim 20, wherein the absorber container is configured such that, as a result of pressure and/or partial pressure differences and/or changes which are produced by the absorption of the reaction product in the absorber, the flow of the reaction product into and/or through the absorber is actuated.

31. A method as claimed in claim 16, wherein the fuel cell includes a chamber and at least one chemical absorber, associated with the chamber, with which at least one reaction product produced in the fuel can be absorbed.

32. A method as claimed in claim 31, wherein the at least one reaction product contains or is CO₂.

33. A method as claimed in claim 31, wherein the chamber comprises a reaction chamber and/or an anode chamber and the absorber is disposed in an absorber container which is connected to the reaction chamber and/or to the anode chamber of the fuel cell via a line which is permeable for the reaction product.

34. A method as claimed in claim 33, wherein the reaction chamber and/or the anode chamber is connected to the absorber container via at least one phase separation membrane.

35. A method as claimed in claim 34, wherein the absorber container is configured with a tank of the fuel cell as an integral unit.

36. A method as claimed in claim 35, wherein the absorber container is configured with the tank as a common cartridge which can be connected to the fuel cell such that a connection which is permeable for a fuel is produced between the tank and the reaction chamber and/or anode chamber and a connection which is permeable for the reaction product is produced between the absorber container and the reaction chamber or anode chamber, the tank and the absorber container preferably being connectable together to the reaction chamber.

37. A method as claimed in claim 31, wherein the absorber comprises or consists of carbon dioxide absorbent lime and/or Ca (OH)₂.

38. A method as claimed in claim 35, wherein the fuel cell and/or the absorber container and/or the tank together form a closed system.

39. A method as claimed in claim 35, wherein the absorber container is disposed and/or configured such that, during absorption of the reaction product by the absorber, released reaction heat and/or released reaction water can be used for the fuel cell reaction, that the absorber container is disposed surrounding the tank with the tank in a thermally conducting connection and/or that the absorber container comprises or consists of a heat-conductive material and/or in that at least one heat exchanger is disposed between the absorber container and the tank and/or between the absorber container and the reaction chamber and/or the anode chamber.

40. A method as claimed in claim 31, wherein the fuel cell is a direct alcohol fuel cell and/or a direct methanol fuel cell.

41. A method as claimed in claim 31, wherein the fuel cell is a liquid-operated fuel cell or a gas-operated fuel cell.

42. A method as claimed in claim 33, wherein the absorber container has at least one flow channel and/or at least one tapered section and/or at least one baffle plate with which the reaction product can be conducted through the absorber container.

43. A method as claimed in claim 33, wherein the absorber container is configured such that, as a result of pressure and/or partial pressure differences and/or changes which are produced by the absorption of the reaction product in the absorber, the flow of the reaction product into and/or through the absorber is actuated.
